(19) United States
(12) Patent Application Publication
(10) Pub. No.: US 2014/0287625 A1
(43) Pub. Date: Sep. 25, 2014

(54) METHOD, APPARATUS, AND MANUFACTURE FOR ENHANCED RESOLUTION FOR IMAGES FROM HIGH DYNAMIC RANGE (HDR) INTERLACED SENSORS

(71) Applicant: ZK-TEK Technologies Co., Ltd., New Taipei City (TW)

(72) Inventor: Yi Chia CHAN, New Taipei City (TW)

(21) Appl. No.: 13/932,907

(22) Filed: Jul. 1, 2013

(30) Foreign Application Priority Data
Mar. 20, 2013 (TW) 102205164

(51) Int. Cl. H01R 13/648

(52) U.S. Cl. CPC H01R 13/648
USPC 439/607.01

(57) ABSTRACT

The present invention relates to a USB connector assembly, and more specifically, refers to a connector structure which is applied in memory device of USB drive.

### BACKGROUND OF THE INVENTION

1. Field of the Invention

The present invention relates to a USB connector assembly, comprising an isolated block, which is configured and laid with a plural of conducting pins, a front shell, which is inserted by the isolated block and is both laterally extended as clipping arms, and a casing, which is formed at the rear position of said isolated block and the front shell. The isolated block and the casing are configured with coupling structure to combine and fit with each other correspondingly. By such a joint assembly, the present invention can provide a stable assembled structure and enhance a firm supporting ability to reduce the transmission failure and/or error between pins and the entire structure after many times plug-in and pull-out.

2. Description of Prior Art

The USB (Universal Serial Bus) connectors had been widely adopted as a standard port to function as a transmission interface between the computer and external peripherals. Especially, USB connectors are popularly used in memory storage device and equipped with function of ‘hot plugging’ or ‘plug and play’. Following the trend to be lighter, thinner and smaller, there are several USB connectors' specification had been released. They are standard A type, B type, Mini USB and Micro USB. So far, most of the USB connectors adopted in portable drive are standard A type. However, Micro USB B type was used in mobile phone and mini laptop for the recent years. There must be some bridge to connect between USB standard A type and Micro USB B type for expanding the memory size.

Prior USB B type connectors usually adopted a metal front shell to wrap a plastic isolated block which is laid with a plural of conducting pins. The whole USB connector is supported by the conducting pins soldered with the base which is located at the back of USB drive. And, it resulted into a transmission failure between pins and the base after many times plug-in and pull-out due to a poor contact status.

In view of the above discussed problems, the present invention aims to improve such a transmission failure and provide a convenient method to enhance the structure assembly for USB connectors.

### SUMMARY OF THE INVENTION

To achieve the purpose described above, the present invention, a USB connector assembly, comprises:

an isolated block, which is configured with a plural of conducting pins,

a front shell, which is inserted by the isolated block and is both laterally extended as clipping arms, and

a casing, which is further configured at the rear position of said isolated block and the front shell, and the isolated block and the casing are configured with coupling structure to combine with each other correspondingly.

The said coupling structure can be alternatively applied at either top or lower side simultaneously. Meanwhile, the coupling structure of the casing can be a notch with or without a penetrable opening, and that of the isolated block is a protruding rib. Or, the coupling structure of the casing is a protruding rib and that of the isolated block is a notch.

Furthermore, the clipping arms are laterally configured at both sides of the front shell, and are further configured with upper fixing parts and lower fixing parts, wherein there is a clipping space formed to hold and accommodate the base between said fixing parts, to provide a stable supporting ability with the base, and to reduce transmission failure between pins and the base after repeated plug-in and pull-out.

The clipping arms are, alternatively, configured with upper fixing parts and side stoppers, which have a firm attachment at the top surface and the front side of the base respectively.

By above-mentioned description, the present invention is applicable to provide a USB connector structure with a more efficient manufacturing process and a more reliable hardware structure. Above all, the present invention is assembled free from soldering and provides a convenient and efficient method to shorten prior USB connector manufacturing process.

The function and structure of practical embodiments can be further understood via the drawings listed below.

### BRIEF DESCRIPTION OF THE DRAWINGS AND ELEMENTS

The present invention can be fully understood from the following detailed description and preferred embodiment with reference to the accompanying drawings, in which:

FIG. 1 illustrates a schematic elevation view of the first embodiment related to the present invention.

FIG. 2 illustrates a decomposition view of the first embodiment.

FIG. 3 illustrates a schematic elevation view without casing of the first embodiment.

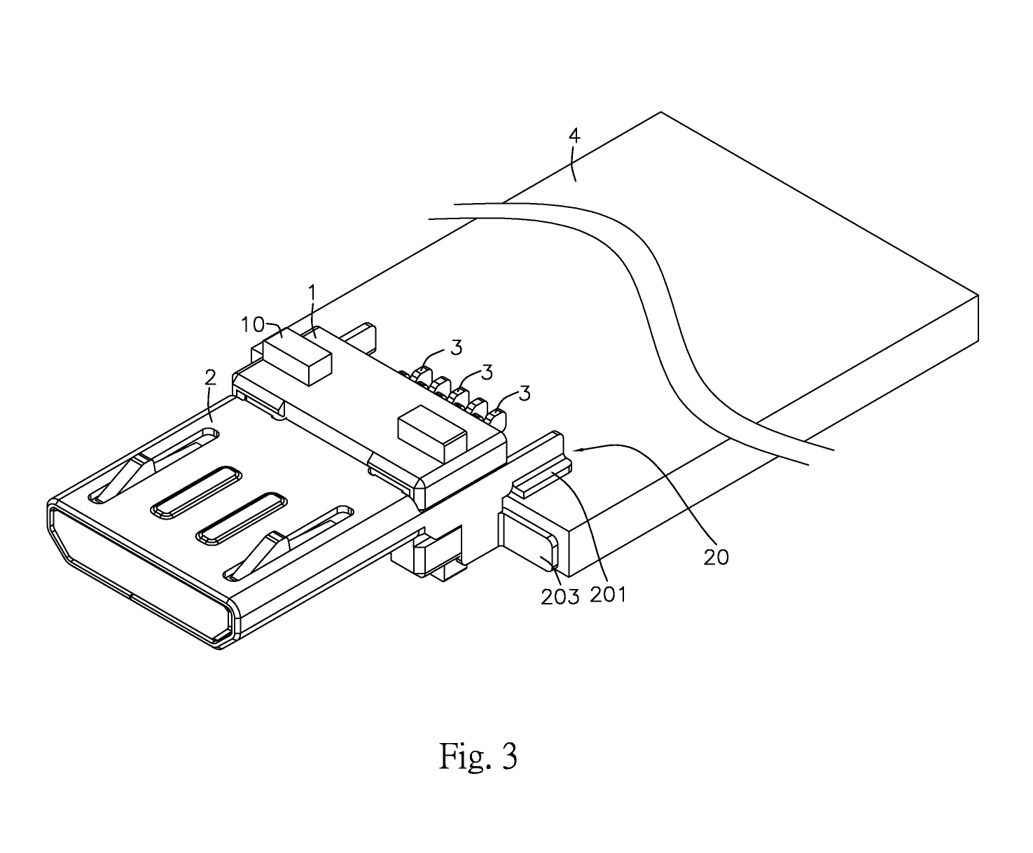

FIG. 4 illustrates a schematic cross-section view of the first embodiment.

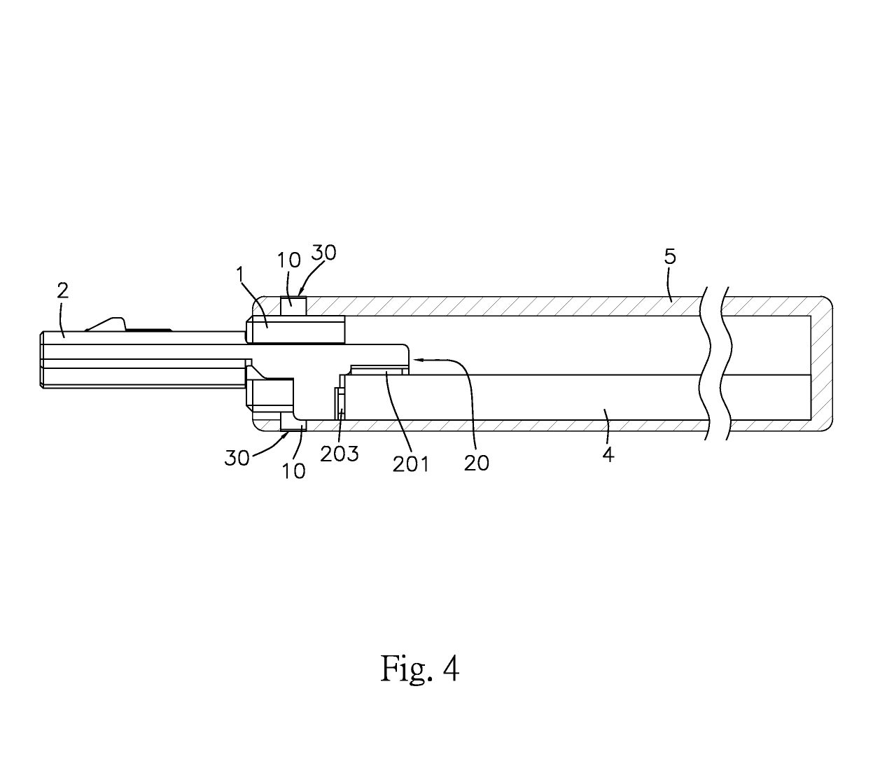

FIG. 5 illustrates a schematic elevation view of the second embodiment.

FIG. 6 illustrates a schematic cross-section view the second embodiment.

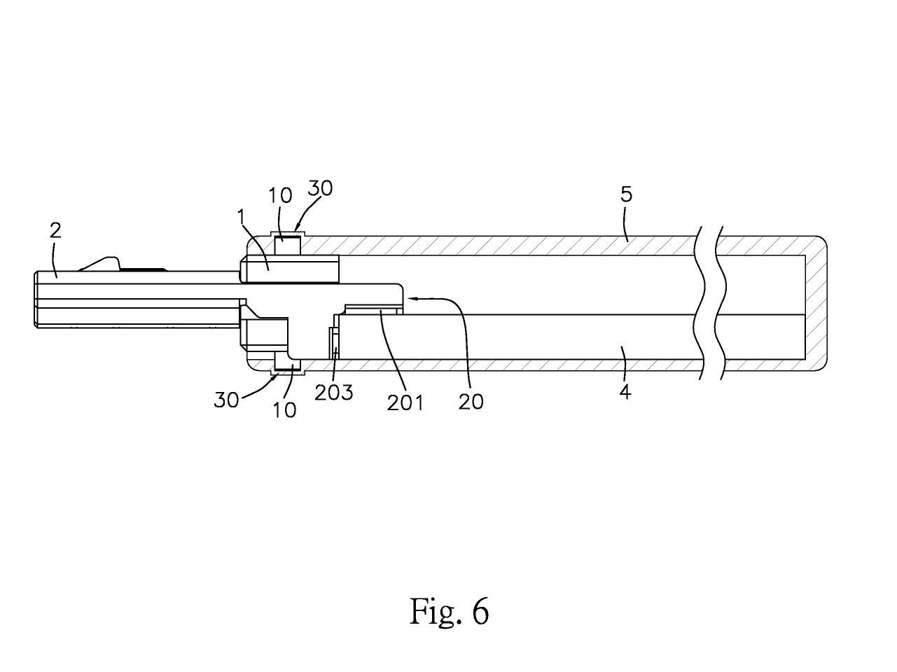

FIG. 7 illustrates a schematic elevation view of the third embodiment.

FIG. 8 illustrates a schematic cross-section view of the third embodiment.

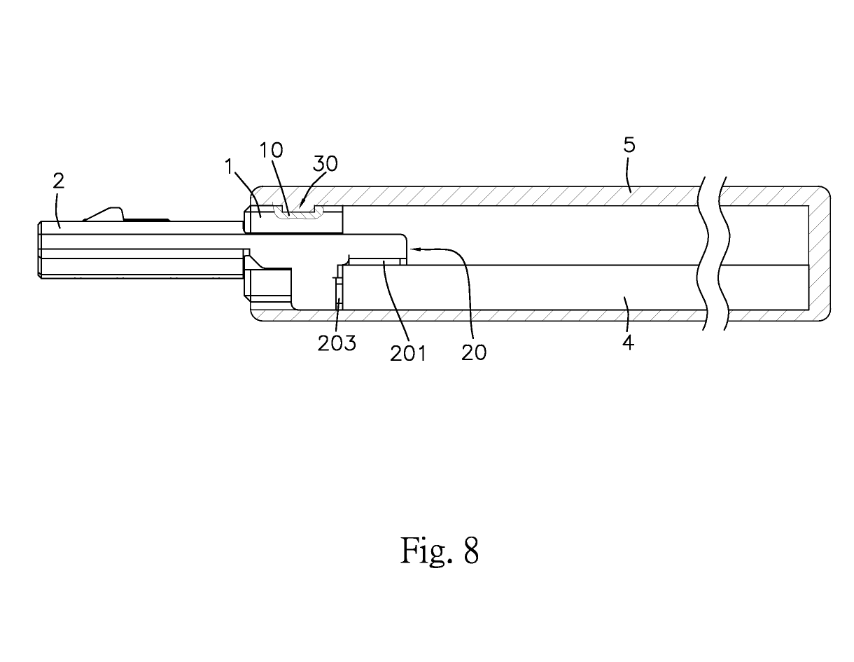

FIG. 9 illustrates a decomposition view of the fourth embodiment.

FIG. 10 illustrates a schematic elevation view related to the fourth embodiment.

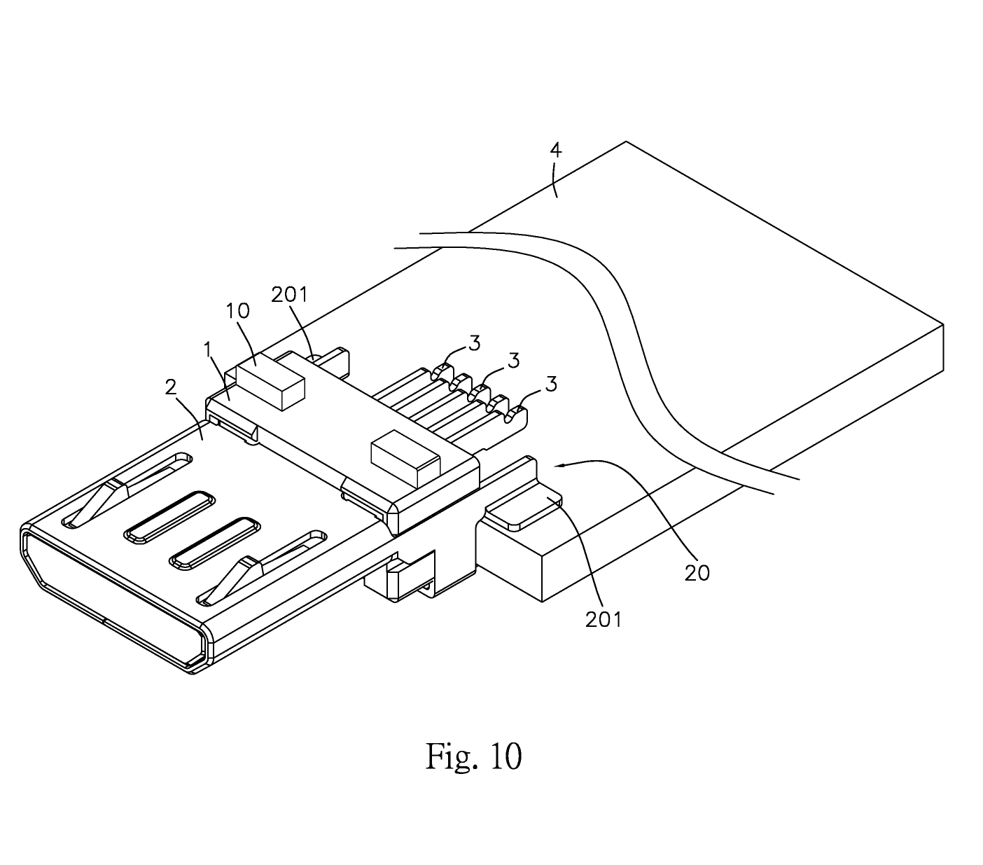

FIG. 11 illustrates a schematic cross-section view of the fifth embodiment.

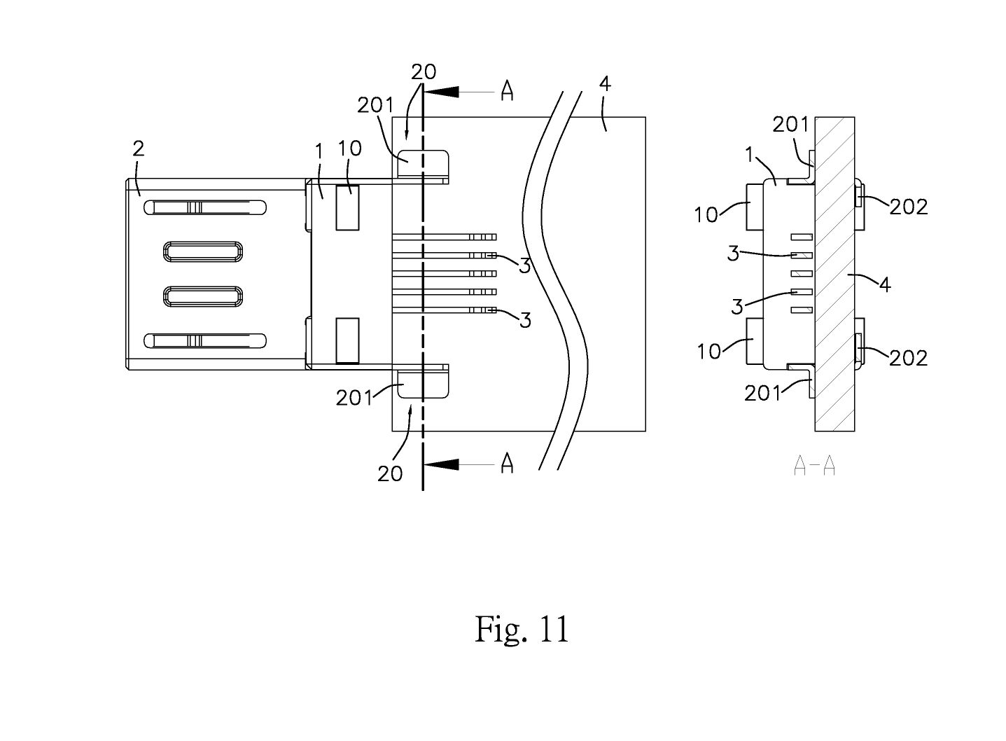

The elements related to the present invention are listed as follows:

| | | | |
|---|---|---|---|
| 1, | isolated block | 2, | front shell |
| 3, | pins | 4, | base |
| 5, | casing | 10, | coupling structure |
| 20, | clipping arms | 30, | coupling structure |
| 201, | upper fixing part | 202, | lower fixing part |
| 203, | side stopper | | |

### DETAILED DESCRIPTION OF THE PREFERRED EMBODIMENTS

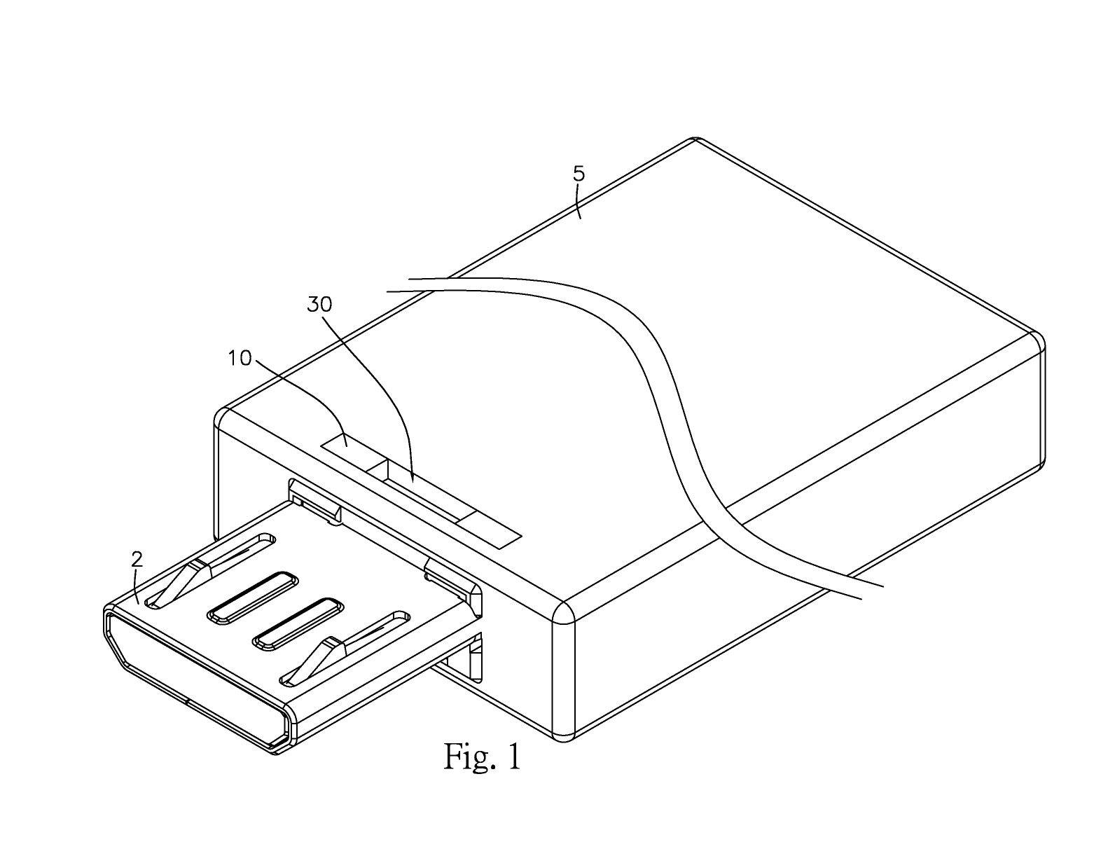

Referring to FIGS. 1˜4, which illustrate a schematic elevation view of, a decomposition view, a schematic elevation view without casing and a schematic cross-section view related to the first embodiment. The present invention, a USB connector assembly, comprises an isolated block 1, a front shell 2 and a casing 5, wherein the isolated block 1 is configured with a plural of conducting pins 3 which are laid and fixed over the base 4 and enables electrical connection. The base 4 is, but not limited as, a COB (Chip-On-Board) structure. The front shell 2 can be configured with metal material and is inserted by the isolated block 1. The isolated block 1 is then wrapped by the front shell 2 which is both laterally extended as clipping arms 20. The casing 5 is further configured at the rear position of said isolated block 1 and the front shell 2, and the isolated block 1 and the casing 5 are configured with coupling structure 10, 30 to combine with each other correspondingly. The said coupling structure 10, 30 can be alternatively applied at either top or lower side of the joint structure isolated block 1 and casing 5 at the same time. And, the clipping arms 20 are further including upper fixing parts 201 and lower fixing parts 202, wherein there is a clipping space formed to hold and accommodate the base 4 between said fixing parts 201, 202, to provide a stable supporting ability with the base 4, and to balance the stress focused on the pins 3 and to reduce transmission failure between pins 3 and the base 4 after repeated plug-in and pull-out.

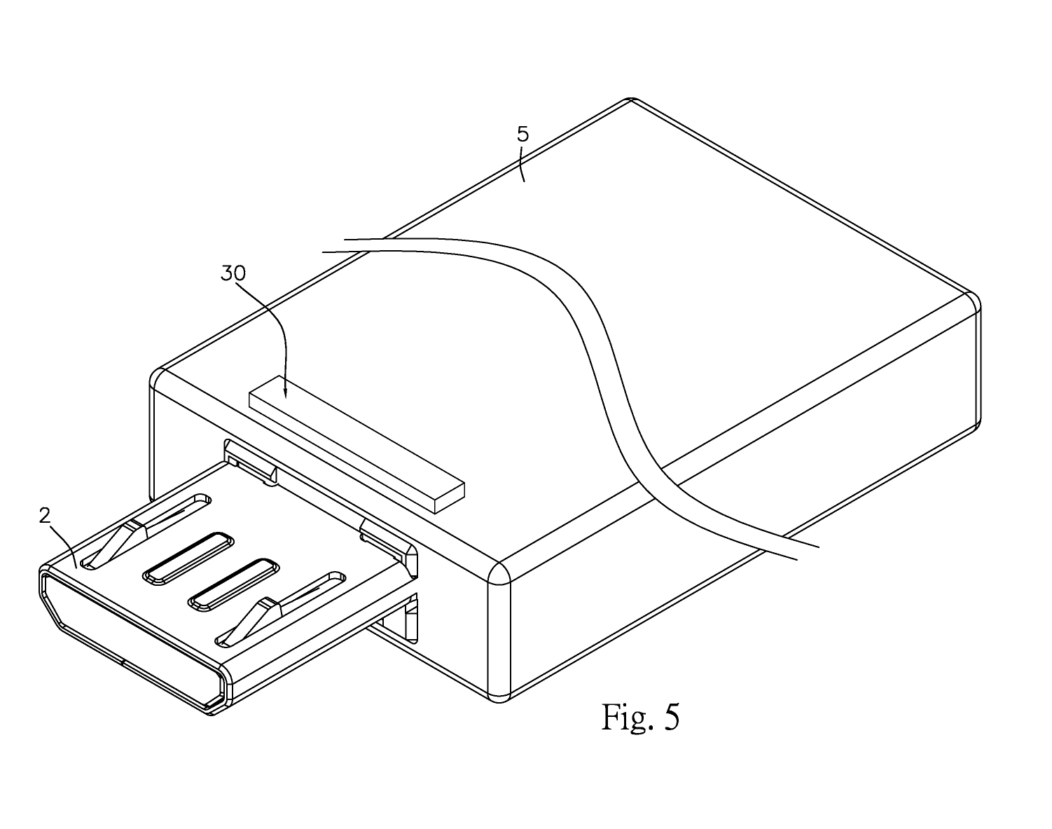

Please refer to FIGS. 5˜6, which illustrate a schematic elevation view and a schematic cross-section view of the second embodiment, which is different from the first embodiment and the difference lies in that either top or lower side of the coupling structure 30 in casing 5 is a notch without a penetrable opening.

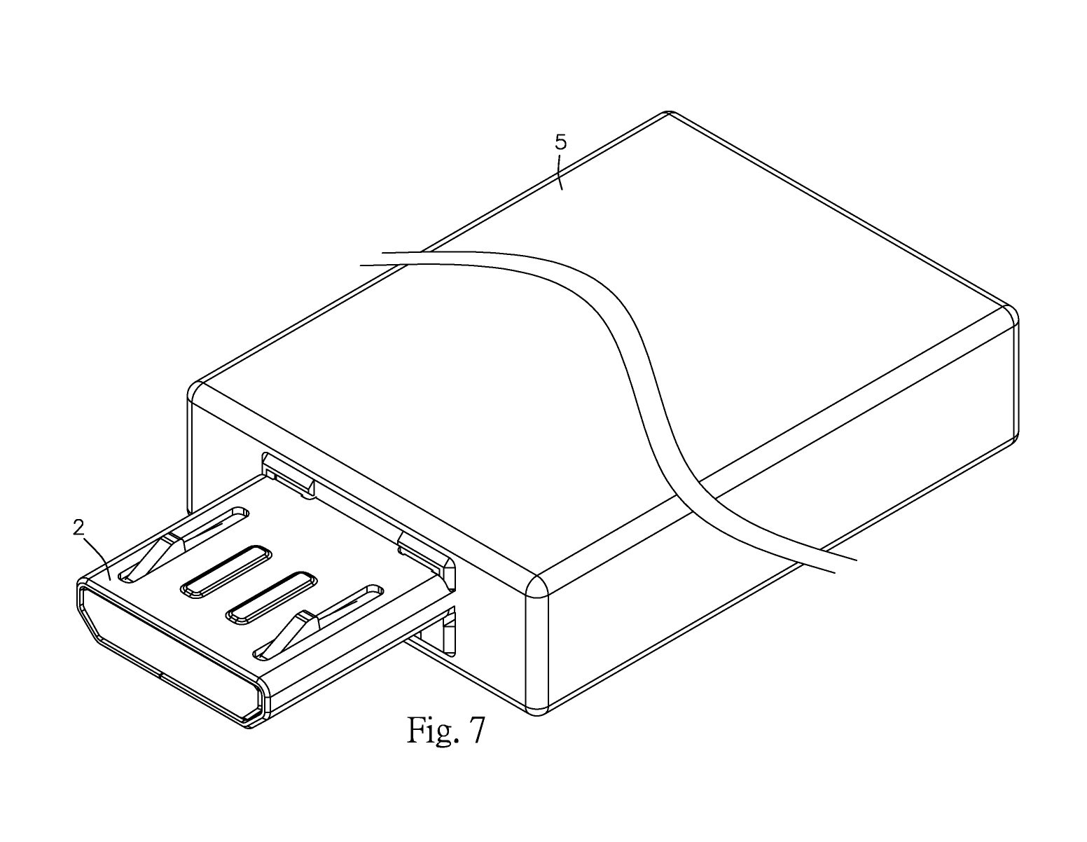

Please refer to FIGS. 7˜8, which shows the third embodiment related to the present invention, wherein the coupling structure 30 of casing is an inner forward protruding rib, and the coupling structure 10 of the isolated block 1 is a long strip notch which enables a stable and firm structural combination between isolated block 1 and casing 5, and provides a continual support among the base 4 and those conducting pins 3.

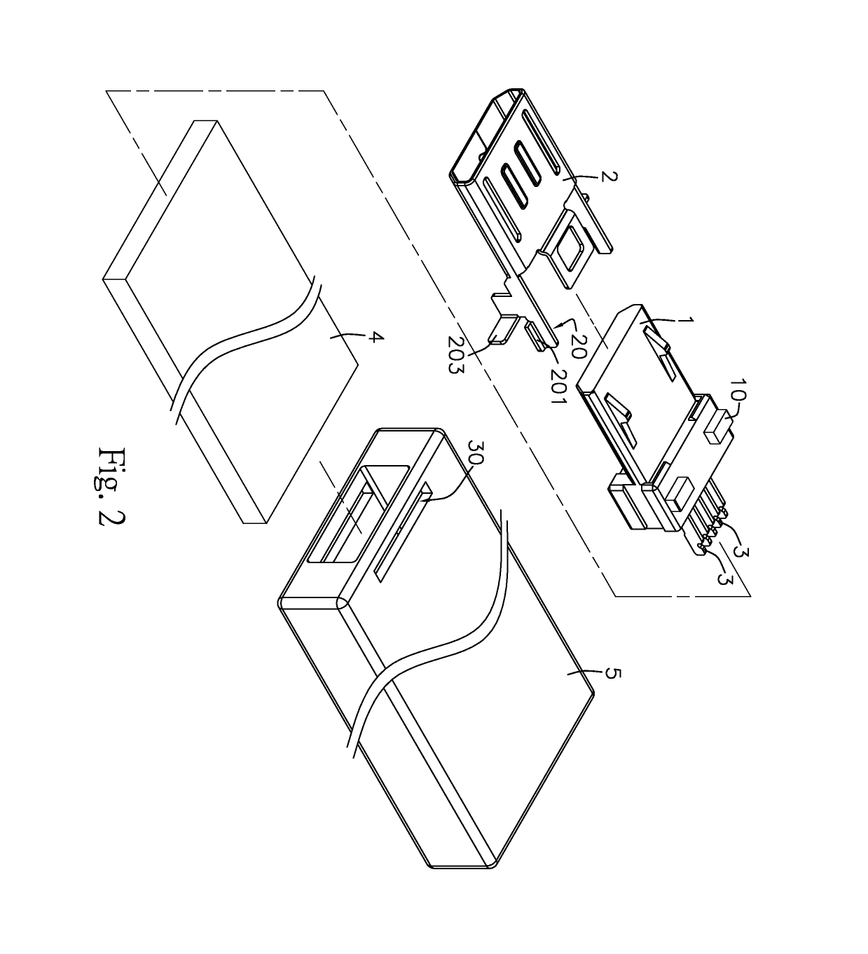

Please refer to FIGS. 2˜3. The front shell 2 is laterally configured with clipping arms 20 which are further including upper fixing parts 201 and side stoppers 203 at both sides which have a firm attachment at the top surface and the front side of the base respectively to reduce transmission failure between pins and the base after repeated plug-in and pull-out.

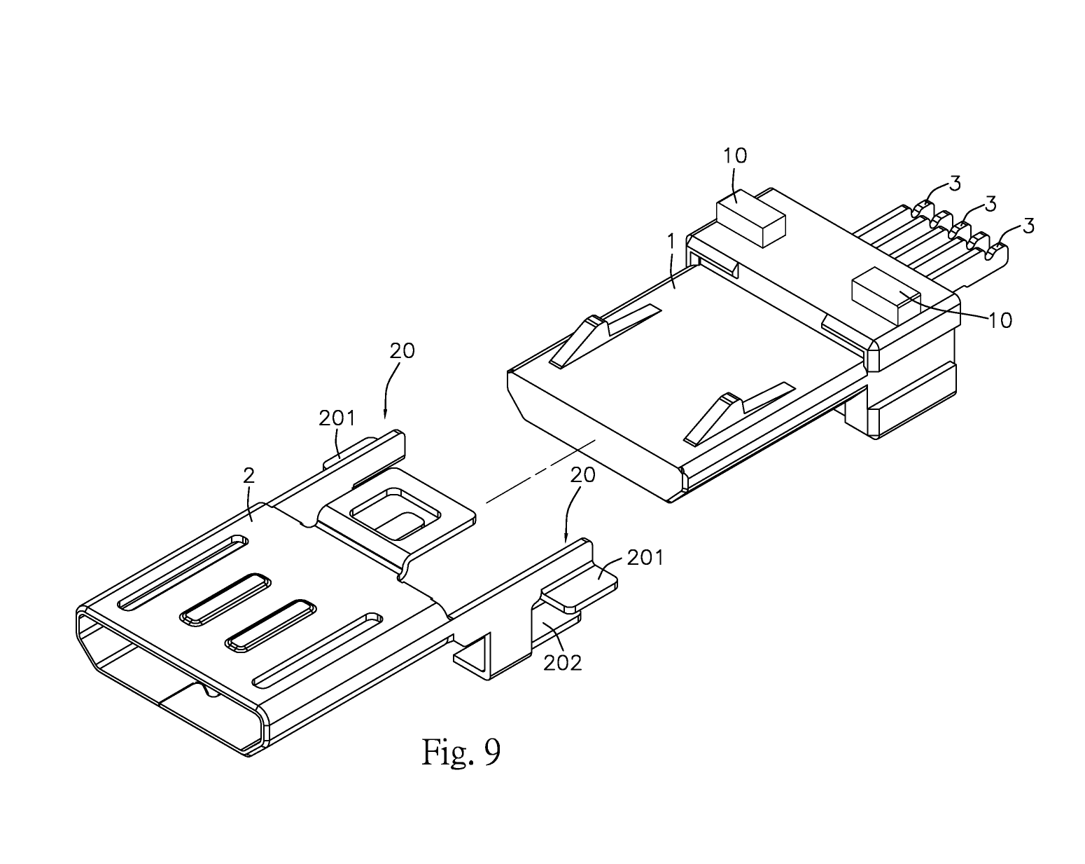

Please refer to FIGS. 9˜11, which shows the fourth embodiment related to the present invention, wherein the clipping arms 20 are further including upper fixing parts 201 and lower fixing parts 202 at both sides to provide a stable supporting ability with the base 4 and a clipping space formed to hold and accommodate the base 4 between said fixing parts.

According to the description above, it is to be understood that the embodiments described herein are merely some illustrations related to the objects of the invention and that a wide variety of modifications thereto may be adopted without departing from the purpose and the scope of the present invention as set forth in the following claims.

What is claimed is:

1. A USB connector assembly, comprises
an isolated block, which is configured and laid with a plural of conducting pins,
a front shell, which is inserted by the isolated block, and
a casing, which is further configured at the rear position of said isolated block and the front shell, and the isolated block and the casing are configured with coupling structure to combine with each other correspondingly.

2. A USB connector assembly according to claim 1, wherein the front shell is both laterally extended as clipping arms.

3. A USB connector assembly according to claim 1, wherein the coupling structure of the casing is a notch with or without a penetrable opening, and the coupling structure of the isolated block is a protruding rib.

4. A USB connector assembly according to claim 3, wherein the coupling structure configured in casing and isolated block are alternatively applied at either top or lower side simultaneously.

5. A USB connector assembly according to claim 1, wherein the coupling structure of the casing is a protruding rib and the coupling structure of the isolated block is a notch.

6. A USB connector assembly according to claim 2, wherein the clipping arms are further configured with upper fixing parts and lower fixing parts.

7. A USB connector assembly according to claim 6, wherein there is a clipping space formed between upper fixing parts and lower fixing parts to accommodate the base.

8. A USB connector assembly according to claim 2, wherein the clipping arms are further configured with upper fixing parts and side stoppers.

9. A USB connector assembly according to claim 8, wherein the upper fixing parts have an attachment at the top surface and the side stoppers stop the front side of the base respectively.
